(19) United States
(12) Patent Application Publication
(10) Pub. No.: US 2025/0208297 A1
(43) Pub. Date: Jun. 26, 2025

(54) DISTANCE MEASURING APPARATUS

(71) Applicant: CANON KABUSHIKI KAISHA, Tokyo (JP)

(72) Inventor: HIDETOSHI KEI, Tokyo (JP)

(21) Appl. No.: 18/973,652

(22) Filed: Dec. 9, 2024

(30) Foreign Application Priority Data
Dec. 20, 2023 (JP) 2023-214343

(51) Int. Cl. G01S 17/894; G06F 3/01; H04N 23/667

(52) U.S. Cl. CPC G01S 17/894; G06F 3/016; H04N 23/667

(57) ABSTRACT

A distance measuring apparatus includes a distance measuring unit configured to measure a distance to an object, an imaging unit configured to capture still and moving images of the object, a display unit configured to display an object image obtained by the imaging unit, a vibrator configured to generate vibration in a case where the distance is measured by the distance measuring unit, and a processor configured to control the vibrator so as not to generate the vibration in a case where the distance measuring unit measures the distance during moving image capturing, and control the display unit to display an image in which information indicating that the distance has been measured by the distance measuring unit is superimposed on the object image.

### BACKGROUND

### Technical Field

The present disclosure relates to a distance measuring apparatus having an imaging function.

### Description of Related Art

A distance measuring apparatus has conventionally been known that can measure a distance to an object that reflects light based on the time of flight (ToF) of light from when the light is emitted to when the reflected light is detected (see Japanese Patent Laid-Open No. 2014-115191).

Japanese Patent Laid-Open No. 2023-009598 discloses an image pickup apparatus that includes a vibration device that provides the user with an operation sense and is switchable between a first state for transmitting vibrations to an optical member and a second state for stopping transmitting vibrations to the optical member.

Japanese Patent Laid-Open No. 2014-115191 is silent about recording of a still image, a moving image, or audio data when a distance to an object is obtained.

The image pickup apparatus disclosed in Japanese Patent Laid-Open No. 2023-009598 may cause image blur or record vibration noise through the built-in microphone due to the vibration of the vibration device during moving image capturing.

### SUMMARY

A distance measuring apparatus according to one aspect of the disclosure includes a distance measuring unit configured to measure a distance to an object, an imaging unit configured to capture still and moving images of the object, a display unit configured to display an object image obtained by the imaging unit, a vibrator configured to generate vibration in a case where the distance is measured by the distance measuring unit, and a processor configured to control the vibrator so as not to generate the vibration in a case where the distance measuring unit measures the distance during moving image capturing, and control the display unit to display an image in which information indicating that the distance has been measured by the distance measuring unit is superimposed on the object image.

Further features of various embodiments of the disclosure will become apparent from the following description of embodiments with reference to the attached drawings.

### BRIEF DESCRIPTION OF THE DRAWINGS

FIG. 1 is a block diagram of a distance measuring apparatus according to this embodiment of the present disclosure.

FIG. 2 is an external perspective view of the distance measuring apparatus viewed from the front side.

FIG. 3 is an external perspective view of the distance measuring apparatus viewed from the rear side.

FIGS. 4A and 4B illustrate distance measuring information display when the distance measuring apparatus captures a still image.

FIG. 5 is a flowchart illustrating a flow from live-view display to a recording end in distance measurement during moving image capturing with the distance measuring apparatus.

FIGS. 6A and 6B illustrate distance measuring information display during moving image capturing with the distance measuring apparatus.

FIG. 7 illustrates distance measuring information display during moving image capturing with the distance measuring apparatus.

FIG. 8 is a flowchart illustrating a flow from live-view display to a recording end in a simultaneous recording mode of the distance measuring apparatus.

### DETAILED DESCRIPTION

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure. Corresponding elements in respective figures will be designated by the same reference numerals, and a duplicate description thereof will be omitted.

In this embodiment, distance measurement refers to measurement of a distance to an object. In this embodiment, a distance measuring apparatus measures a distance using a method of calculating the distance to the object from when a laser beam is irradiated onto an object and to when the reflected light is detected, but the present disclosure is not limited to this example.

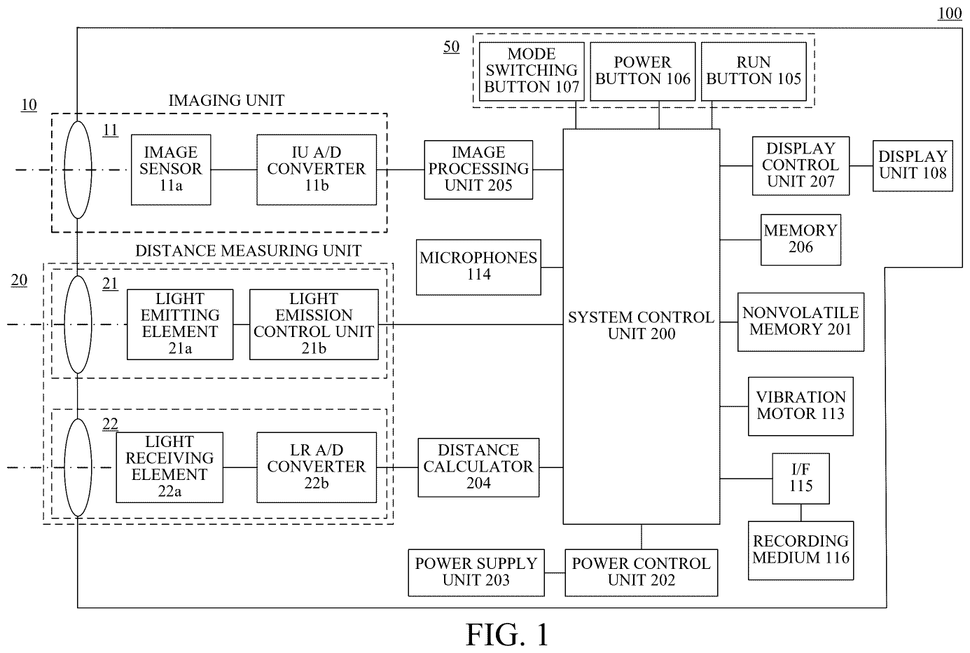

FIG. 1 is a block diagram of a distance measuring apparatus 100 according to this embodiment of the present disclosure. The distance measuring apparatus 100 has a function as a distance measuring unit that measures a distance using a laser beam for distance measurement and a function as an image pickup apparatus that images an object.

The imaging unit 10 includes an imaging lens unit 11, an image sensor 11a, and an imaging unit (IU) A/D converter 11b, and can capture still and moving images. The image sensor 11a includes a CCD, a CMOS, or the like, and converts an optical image condensed by the imaging lens unit 11 into an electrical signal (analog signal). The IU A/D converter 11b converts the analog signal into a digital signal.

An image processing unit 205 performs predetermined pixel interpolation, resizing processing such as reduction, and color conversion processing for the data from the IU A/D converter 11b. The image processing unit 205 also performs predetermined calculation processing using the captured image data, and the system control unit 200 performs exposure control and the like based on the obtained calculation result. Thereby, through-the-lens (TTL) autofocus (AF) processing and (auto-exposure) AE processing are performed. The output data from the IU A/D converter 11b is written to the memory 206 via the image processing unit 205. The distance measuring unit 20 includes an exit lens unit 21, a light emitting element 21a that emits laser beam for distance measurement, and a light emission control unit 21b. The distance measuring unit 20 further includes a light receiving lens unit 22, a light receiving element 22a that receives a laser beam for distance measurement, and a LR A/D converter 22b. The light emitting element 21a includes, for example, a semiconductor laser (laser diode), and a wavelength range of used light is an invisible light range such as near infrared light. The light receiving element 22a includes, for example, an avalanche photodiode. In a case where the light receiving element 22a receives reflected light, it performs photoelectric conversion and outputs a light receiving signal (analog signal).

In distance measurement, the laser beam emitted by the light emitting element 21a irradiates an object through the exit lens unit 21. The laser beam reflected by the object reaches the light receiving element 22a through the light receiving lens unit 22. At this time, the light emission timing by the light emitting element 21a is controlled by the light emission control unit 21b. The laser beam received by the light receiving element 22a is converted from the analog signal to a digital signal by the LR A/D converter 22b. A distance calculator 204 calculates distance information from the reciprocation time of the laser beam, and writes the distance information into the memory 206 via the system control unit 200.

The image data and distance measurement data written to the memory 206 are converted into a file in the file portion in the system control unit 200, and are recorded in the recording medium 116 via an interface (I/F) 115.

A power supply unit 203 includes a primary battery such as an alkaline battery and a lithium battery, a secondary battery such as a NiCd battery, a NiMH battery, and a Li battery, and an AC adapter. A power control unit 202 detects the remaining battery level. The power control unit 202 includes a battery detection circuit, a DC-DC converter, and a switch circuit for switching between blocks to be electrified. Based on the detection result and the control of the system control unit 200, the power control unit 202 controls the DC-DC converter to supply the necessary voltage for the necessary period to each functional unit (including the recording medium 116).

A display unit 108 includes an electronic viewfinder (EVF) such as an LCD or organic EL, and is used to check the image data input by the imaging unit 10, the distance information calculated by the distance calculator 204, and the like. The display unit 108 is controlled by the display control unit 207.

The operation unit 50 includes a run button (instructing unit) 105, a power button 106, and a mode switching button 107. The user can switch between the power-on and power-off of the distance measuring apparatus 100 by pressing the power button 106. In the power-on state, the user can switch the operation mode of the distance measuring apparatus 100 by operating the mode switching button 107. The operation modes of the distance measuring apparatus 100 include an imaging mode, a distance measurement mode, and a simultaneous recording mode. Pressing and holding on the mode switching button 107 can transition to a setting screen for imaging and distance measurement conditions. The user can start imaging or distance measurement by pressing a run button 105 during imaging or distance measurement. The user can determine a setting item by pressing the run button 105 on the setting screen.

The microphone 114 can record external sound during moving image capturing. A vibration motor 113 is built into the distance measuring apparatus 100, and can inform the user that the distance measurement has been successful by generating vibrations during distance measurement, as described below.

A nonvolatile memory 201 is an electrically erasable and recordable memory, such as an EEPROM, and records constants and programs for the operation of the system control unit 200.

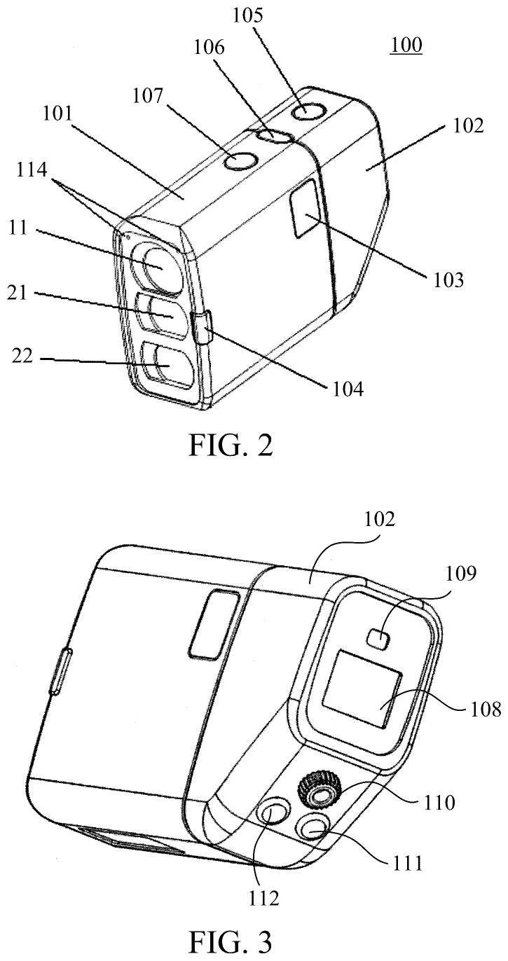

A description will now be given of the external configuration of the distance measuring apparatus 100. FIG. 2 is an external perspective view of the distance measuring apparatus 100 viewed from the front side. A front cover 101 and a rear cover 102 form the external appearance of the distance measuring apparatus 100. An I/F cover 103 is provided on the side of the distance measuring apparatus 100 so that it can be opened and closed. Provided inside the I/F cover 103 are the interface 115 such as a card slot (not illustrated) which a memory card for recording captured images can be inserted into and ejected from, and an input/output (I/O) jack (not illustrated) for power and signals.

An indicator 104 is provided on the front side of the front cover 101. The mode state of the distance measuring apparatus 100 can be notified to the user and people around it by turning on or blinking an LED (not illustrated) inside the indicator 104. Microphones 114 are disposed on the left and right sides of the front of the front cover 101. This allows external sound to be recorded during moving image capturing.

The run button 105, power button 106, and mode switching button 107 are disposed on the top of the distance measuring apparatus 100, and can be pressed to execute setting items, perform imaging and distance measurement operations, turn on and off the power, and switch between imaging and distance measurement modes. In this embodiment, three types of imaging and distance measurement modes can be selected: an imaging mode for capturing a still image, a distance measurement mode for measuring a distance to an object, and a simultaneous recording mode for simultaneously performing still image capturing and distance measurement.

Openings for the imaging lens unit 11, the exit lens unit 21, and the light receiving lens unit 22 are formed in the front surface of the front cover 101. Thereby, the emission and reception of a laser beam for imaging and distance measurement of an object are performed.

FIG. 3 is an external perspective view of the distance measuring apparatus 100 viewed from the rear side. A display unit 108 is disposed on the rear side of the rear cover 102. In this embodiment, an organic EL panel (not illustrated) is configured inside the display unit 108, and the user can check the captured image and distance measurement information by peeping through the display unit 108. An eye sensor 109 is disposed near the display unit 108 and can detect whether a person or the like is approaching by emitting and receiving infrared light. Thereby, the organic EL panel is displayed only in a case where the user approaches the display unit 108 to peep through it, and power consumption of the distance measuring apparatus 100 can be suppressed.

A diopter adjusting dial 110, a moving image button 111, and a selection button 112 are disposed on the bottom side of the rear cover 102. The diopter adjusting dial 110 is used by the user to adjust the diopter of the display unit 108 to suit each individual's vision. The moving image button 111 is pressed to start and stop moving image capturing. The selection button 112 is used to select a setting item with the mode switching button 107.

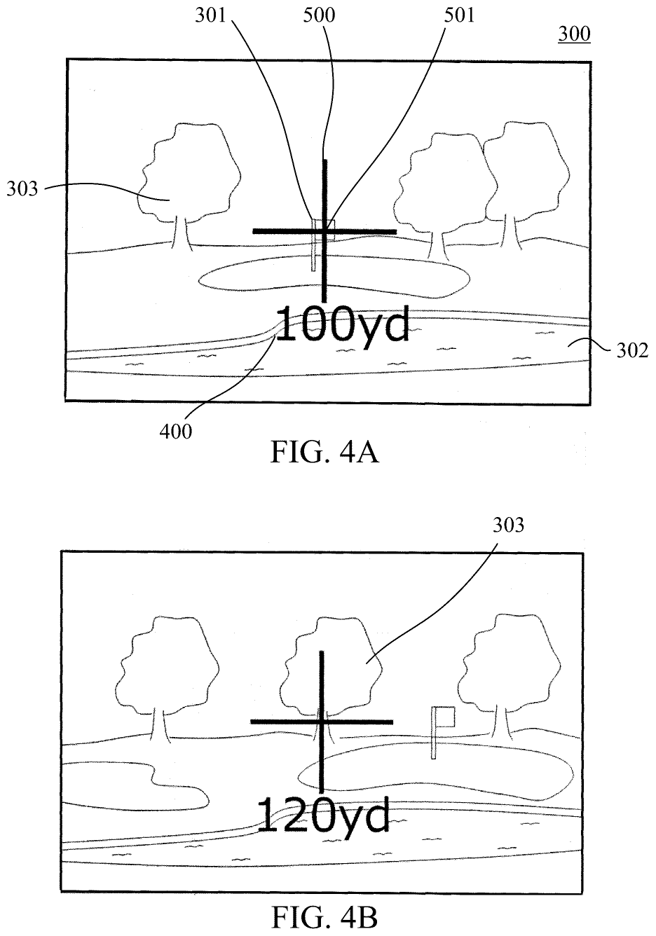

FIGS. 4A and 4B explain the display of distance measurement information during still image capturing of the distance measuring apparatus 100, and illustrate example images displayed after distance measurement in the distance measurement mode or simultaneous recording mode. FIGS. 4A and 4B assume that the distance measuring apparatus 100 is used on a golf course, and a flag 301, a pond 302, a tree 303, etc. are illustrated in a captured image (object image) 300 acquired by the imaging unit 10. FIG. 4A illustrates distance measurement to the flag 301, and FIG. 4B illustrates distance measurement to the trunk of the tree 303.

In an operation mode for performing distance measurement by the operation of the run button 105, an index indicating a distance measurement position is superimposed on a live-view image. FIGS. 4A and 4B illustrate a cross-shaped cursor 500 as an example of the index indicating the distance measurement position, but other types of indices such as a dot-shaped image or an arrow-shaped image may also be used.

The cursor 500 is superimposed so that an intersection 501 is located at a predetermined position on the captured image 300, at the center of the captured image 300 in FIGS. 4A and 4B. The distance measuring unit 20 is adjusted so that it outputs a laser beam toward a position that is within an imaging range of the imaging unit 10 and corresponds to the intersection 501 of the cursor 500. Thus, the user can measure a distance to a desired position by adjusting the orientation of the distance measuring apparatus 100 so that the intersection 501 of the cursor 500 is aligned with the position to be measured, and operating the run button 105.

In a case where the distance measurement is normally performed, distance information 400 regarding the distance from the distance measuring apparatus 100 to the object is superimposed on the live-view image as the measurement result. Although the distance information 400 is superimposed in this embodiment, it is not limited to this example as long as it is information indicating that the distance has been measured.

FIGS. 4A and 4B assume that the distance measuring apparatus 100 is used on a golf course, so the distance is displayed in yards, but it can be displayed in other units such as meters.

A description will now be given of the distance measurement operation during moving image capturing, and the display method of the captured image 300 and distance information 400 on the display unit 108.

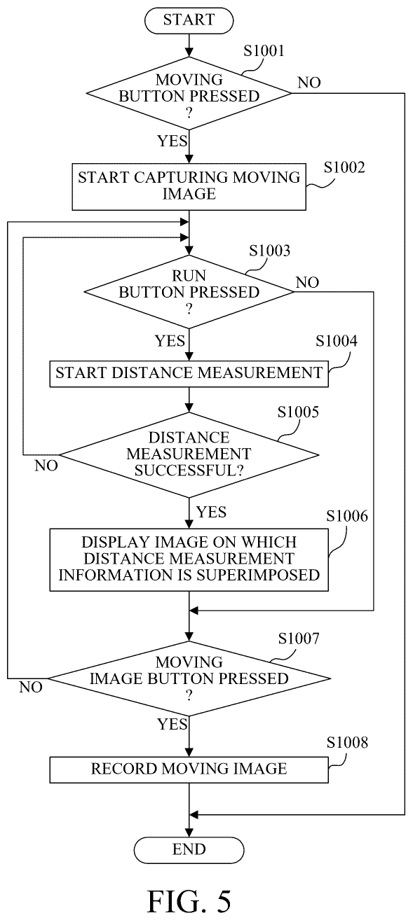

FIG. 5 is a flowchart illustrating a flow from live-view display to a recording end in the distance measurement during moving image capturing with the distance measuring apparatus 100.

The flowchart in FIG. 5 starts when the power is turned on by pressing the power button 106, and live-view image data input by the imaging unit 10 is displayed on the display unit 108 (EVF).

In step S1001, the system control unit 200 determines whether the moving image button 111 has been pressed. In a case where the system control unit 200 determines that the moving image button 111 has been pressed, it executes the processing of step S1002, and in a case where it determines that the moving image button 111 has not been pressed, it ends this flow.

In step S1002, the system control unit 200 starts capturing a moving image.

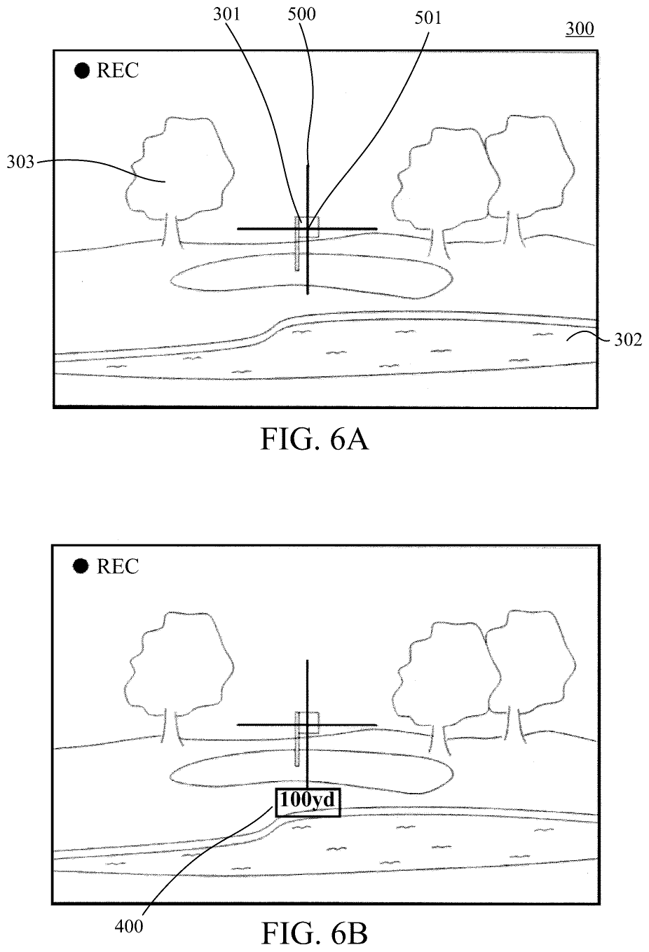

FIGS. 6A and 6B explain distance measurement information display during image capturing of the distance measuring apparatus 100, illustrating a live-view image of the scenery around the green on a golf course. In FIGS. 6A and 6B, the user has set an angle of view to the center on the flag 301 on the green, including the surrounding pond 302, trees 303, etc.

In moving image capturing begins in step S1002, it is assumed that an image illustrated in FIG. 6A is displayed on display unit 108. Here, in a case where the object for the distance measurement is the flag 301, the user can aim a laser beam by aligning the intersection 501 of cursor 500 with the flag 301.

In step S1003, the system control unit 200 determines whether the run button 105 has been pressed. In a case where the system control unit 200 determines that the run button 105 has been pressed, it executes the processing of step S1004, and in a case where it determines that the run button 105 has not been pressed, it executes the processing of step S1007.

In step S1004, the system control unit 200 starts distance measurement.

In step S1005, the system control unit 200 determines whether the distance measurement has been successful. In a case where the system control unit 200 determines that the distance measurement has been successful, it executes the processing of step S1006, and in a case where it determines that the distance measurement has not been successful, it executes the processing of step S1003.

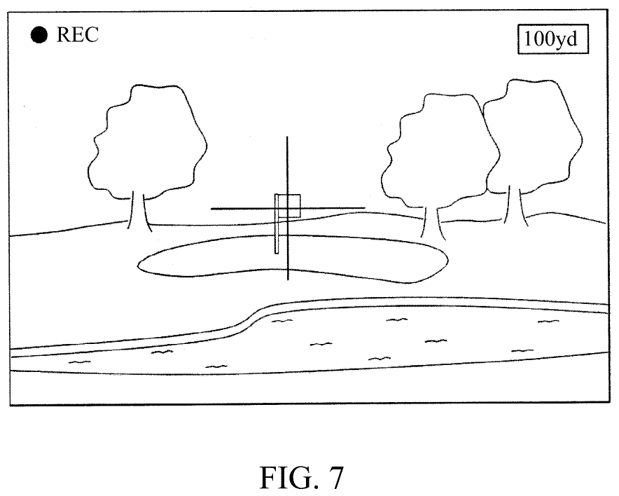

In step S1006, the system control unit 200 causes the display unit 108 to display an image in which the distance information 400 indicating a distance (100 y) to the flag 301 is superimposed on (associated with) the captured image 300, as illustrated in FIG. 6B. Thereby, the captured moving image is displayed with the distance information 400 superimposed, so the user can capture a moving image and measure the distance at the same time. In this embodiment, a text image is used as the distance information 400, but another image such as a distance measurement success mark may be used. In order to improve visibility to the user, the size, color, display location, etc. of the distance information 400 may be changed as illustrated in FIG. 7.

In step S1007, the system control unit 200 determines whether the moving image button 111 has been pressed. In a case where the system control unit 200 determines that the moving image button 111 has been pressed, it executes the processing of step S1008, and in a case where it determines that the moving image button 111 has not been pressed, it executes the processing of step $1003.

In step S1008, the system control unit 200 ends moving image capturing and records the moving image data in the recording medium 116. In a case where the moving image button 111 is pressed after the distance measurement is successful, the image with the distance information 400 superimposed is recorded as moving image data. The moving image data may be recorded in a recorder (not illustrated) built in the distance measuring apparatus 100, rather than in the recording medium 116.

Thus, in a case where the run button 105 is pressed during moving image capturing to perform distance measurement, the user is notified that distance measurement has been successful by displaying an image on which the distance information 400 is superimposed, without performing the vibration operation that occurs in a case where distance measurement is successful. This configuration can prevent slight blurring of the image due to vibrations caused by the vibration motor 113 during moving image capturing, and notify the user that distance measurement has been successful while preventing vibration sounds from being recorded.

A description will now be given of the operation in the simultaneous recording mode and the method of displaying the captured image 300 and distance information 400 on the display unit 108.

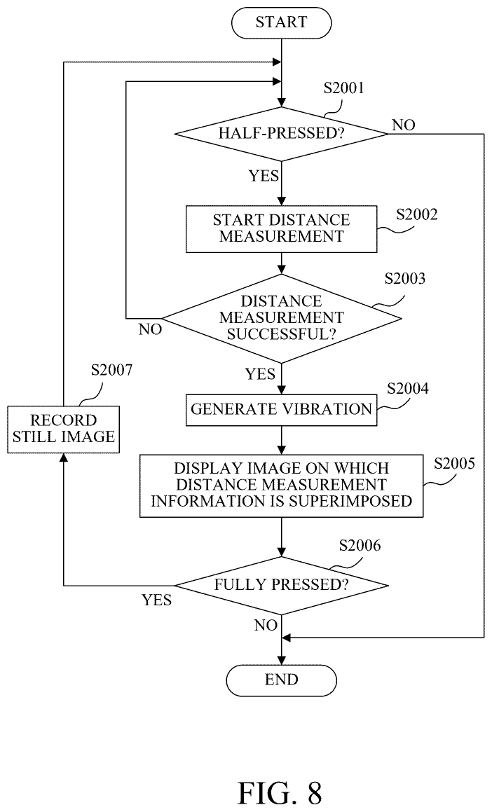

FIG. 8 is a flowchart illustrating a flow from live-view display to a recording end in the simultaneous recording mode of the distance measuring apparatus 100.

In this embodiment, the run button 105 is a two-stage switch consisting of a switch SW1 (not illustrated) and a switch SW2 (not illustrated). In a case where the run button 105 is half-pressed, the switch SW1 is turned on, which instructs the start of a distance measurement operation, AF processing for focusing, and AE processing. In a case where the run button 105 is fully pressed, the switch SW2 is turned on, which instructs the start of an imaging operation and recording of the captured image.

In the flowchart illustrated in FIG. 8, the power button 106 of the distance measuring apparatus 100 is pressed to turn on the power, and the state in which the simultaneous recording mode is set by the mode switching button 107 is started. In this state, the image data input by the imaging unit 10 is displayed as a live-view image on the display unit 108 (EVF).

In step S2001, the system control unit 200 determines whether the run button 105 has been half-pressed. In a case where the system control unit 200 determines that the run button 105 has been half-pressed, the system control unit 200 executes the processing of step S2002, and in a case where it determines that the run button 105 has not been half-pressed, the system control unit 200 ends this flow. Since distance measurement is started in step S2002, it is assumed that in a case where the run button 105 is half-pressed in this flow, the intersection 501 of the cursor 500 is positioned at the object to be measured.

In step S2002, the system control unit 200 starts distance measurement.

In step S2003, the system control unit 200 determines whether the distance measurement has been successful. In a case where the system control unit 200 determines that the distance measurement has been successful, it executes the processing of step S2004, and in a case where it determines that the distance measurement has not been successful, it executes the processing of step S2001.

In step S2004, the system control unit 200 causes the vibration motor 113 to generate vibrations. This allows the user to recognize that the distance measurement has been successful.

In step S2005, the system control unit 200 causes the display unit 108 to display an image in which the distance information 400 is superimposed on the captured image 300.

In step S2006, the system control unit 200 determines whether the run button 105 has been fully pressed. In a case where the system control unit 200 determines that the run button 105 has been fully pressed, it executes the processing of step S2007, and in a case where it determines that the run button 105 has not been fully pressed, it ends this flow.

In step S2007, the system control unit 200 captures a still image of the live-view display on the display unit 108 and records it on the recording medium 116. The still image is recorded with distance information 400 superimposed on the display screen, as illustrated in FIGS. 4A and 4B. The still image may be recorded in an unillustrated recorder built in the distance measuring apparatus 100, rather than on the recording medium 116.

Since the vibration motor 113 vibrates only for a short time while the run button 105 is half-pressed in a case where distance measurement is successful, the vibration stops when the run button 105 is fully pressed. Therefore, shifting the timing when the still image is captured and the timing when the vibration is generated can prevent the vibration from affecting the captured data.

As described above, in the configuration of this embodiment, in a case where distance measurement is successful during moving image capture, the distance information 400 is superimposed on the captured image 300 to notify the user, thereby preventing vibrations from being recorded by the microphones 114. Visibility can be improved by changing the size, color, or location of the distance information 400 and displaying the distance information 400.

In the simultaneous recording mode, shifting the timing of the vibration operation in a case where distance measurement is successful and the timing of still image capture can notify the user of successful distance measurement while vibrations are prevented from affecting the captured image.

### OTHER EMBODIMENTS

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has described example embodiments, it is to be understood that some embodiments are not limited to the disclosed embodiments. The scope of the following claims is to be accorded the broadest interpretation so as to encompass all such modifications and equivalent structures and functions.

This embodiment can provide a distance measuring apparatus that can simultaneously perform distance measurement and recording of imaging data, and that can suppress the influence of vibrations and noise from a vibrator on the imaging data.

This application claims priority to Japanese Patent Application No. 2023-214343, which was filed on Dec. 20, 2023, and which is hereby incorporated by reference herein in its entirety.

What is claimed is:

1. A distance measuring apparatus comprising:
a distance measuring unit configured to measure a distance to an object;
an imaging unit configured to capture still and moving images of the object;
a display unit configured to display an object image obtained by the imaging unit;
a vibrator configured to generate vibration in a case where the distance is measured by the distance measuring unit; and
a processor configured to:
control the vibrator so as not to generate the vibration in a case where the distance measuring unit measures the distance during moving image capturing, and
control the display unit to display an image in which information indicating that the distance has been measured by the distance measuring unit is superimposed on the object image.

2. The distance measuring apparatus according to claim 1, further comprising an instructing unit configured to issue a first instruction that causes the distance measuring unit to measure the distance and the imaging unit to perform focusing, and a second instruction that causes the imaging unit to capture the still image.

3. The distance measuring apparatus according to claim 2, wherein the processor is configured to:
control the vibrator to generate the vibration in a case where the first instruction is issued and the distance measuring unit measures the distance, and
control the vibrator not to generate the vibration and cause the imaging unit to capture the still image in a case where the second instruction is issued.

4. The distance measuring apparatus according to claim 1, wherein the information indicating that the distance has been measured is information regarding a distance from the distance measuring apparatus to the object.

5. The distance measuring apparatus according to claim 1, wherein the processor is configured to change at least one of a size, color, and position of the information indicating that the distance has been measured in a case where the distance measuring unit measures the distance during moving image capturing.

6. The distance measuring apparatus according to claim 1, wherein the distance measuring unit measures the distance to the object by using a time period from when light is irradiated onto the object to when reflected light from the object is received.

7. The distance measuring apparatus according to claim 1, further comprising a recorder configured to record the object image and the information indicating that the distance has been measured in association with each other.
